(19) United States
(12) Patent Application Publication
(10) Pub. No.: US 2008/0243712 A1
(43) Pub. Date: Oct. 2, 2008

(54) FINANCIAL ARRANGEMENT FOR UTILIZING PUBLIC IMPROVEMENT DISTRICTS FOR FUNDING HOUSING PROJECTS

(76) Inventors: Charles P. Clegg, Plano, TX (US); Harry J. James, Garland, TX (US); Lynn Klinefelter, Wylie, TX (US)

Correspondence Address: Michael L. Diaz;Michael L. Diaz, P.C., Suite 200, 555 Republic Drive, Plano, TX, 75074, US

(21) Appl. No.: 11/778,126

(22) Filed: Jul. 16, 2007

Related U.S. Application Data
(63) Continuation-in-part of application No. 11/692,355, filed on Mar. 28, 2007.

(51) Int. Cl. G06Q 40/00

(52) U.S. Cl. 705/36 R

(57) ABSTRACT

A system and method for funding private housing projects utilizing Public Improvement Districts (PIDs). The system includes a home building company constructing a plurality of homes located within the home development. The system includes a financing scheme for financing projects associated with the construction of the plurality of homes by the home building company. The financing scheme includes a PID (or other public/private bond program) assessment program to finance the home development. The PID provides funds to fund the projected and is funded by individual assessments attached to a property of each home. The PID assessment may be transferred to a third party and used as a down payment or a reduction to the sales price of the home by the purchaser.

### RELATED APPLICATIONS

This application is a continuation-in-part of a co-pending U.S. patent application Ser. No. 11/692,355 by Charles P. Clegg, Harry J. James, and Lynn Klinefelter entitled “HOUSING DEVELOPMENT METHOD AND SYSTEM,” filed Mar. 28, 2007 and is hereby incorporated by reference herein.

### BACKGROUND OF THE INVENTION

1. Field of the Invention

This invention relates to housing development. Specifically, and not by way of limitation, the present invention relates to a system and method for funding housing projects utilizing public improvement districts (PIDs).

2. Description of the Related Art

Population growth has resulted in an explosion of new housing developments. As of December, 2006, there were approximately 1,380,000 construction starts per year. Currently, municipalities and other government entities utilize public improvement districts (PIDs) to fund large community related projects. However, currently no housing developments utilize these PIDs to fund private housing development projects. A system and method are needed to utilize PIDs to fund private housing development projects.

Thus, it would be advantageous to have a system and method which funds private housing development projects utilizing PIDs. It is an object of the present invention to provide such a system and method.

### SUMMARY OF THE INVENTION

In one aspect, the present invention is a system and method for funding private housing projects utilizing Public Improvement Districts (PIDs). The system includes a home building company constructing a plurality of homes located within the home development. The system includes a financing scheme for financing a project associated with the construction of the plurality of homes by the home building company. The financing scheme includes a PID assessment program to finance the home development. The PID provides funds to fund the project and is funded by individual assessments attached to a property of each home. The PID assessment may be transferred to a third party and used as a down payment or a reduction to the sales price of the home by the purchaser.

In another aspect, the present invention is a method of funding a project associated with a plurality of homes for a plurality of purchasers. The method begins by determining a private project for use within a home development containing the homes which requires funding. A Public Improvement District (PID) assessment program is implemented to fund the determined project within the home development. The PID provides funds to fund the project and is funded by individual assessments attached to a property of each home. The project is then constructed utilizing the PID assessment program funds to fund the project.

### BRIEF DESCRIPTION OF THE DRAWINGS

FIG. 1 is a simplified block diagram of the entities of a home development system; and

FIG. 2 is a flow chart outlining the steps for funding a private project associated with a home development according to the teachings of the present invention.

### DESCRIPTION OF THE INVENTION

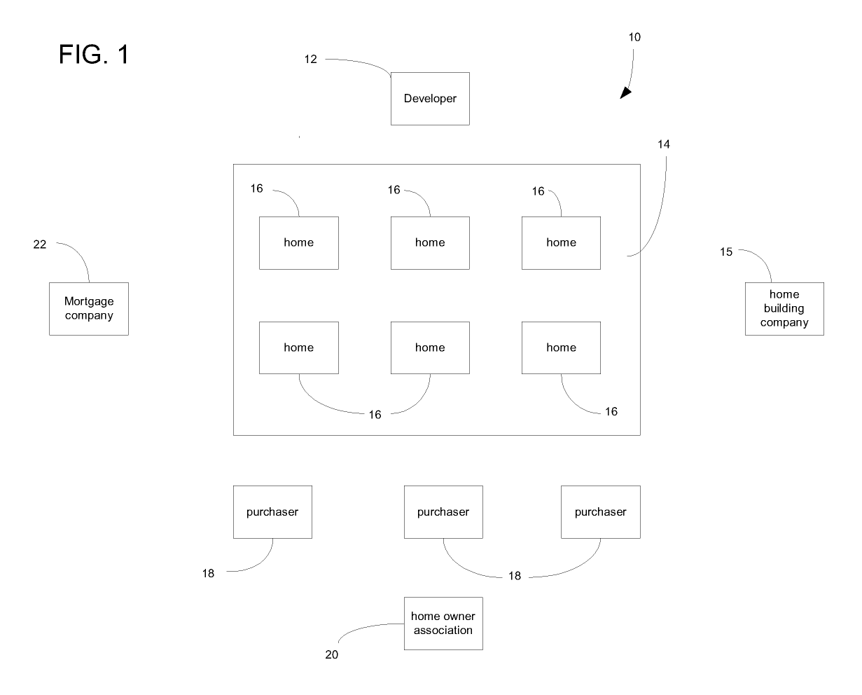

The present invention relates to a system and method for funding private housing projects utilizing PIDs. FIG. 1 is a simplified block diagram of the entities of a home development system 10. The home development system 10 includes a developer 12 of a home development 14. One or more home building companies 15 build a plurality of homes 16 within the home development 14. Each home 16 is purchased by a home purchaser 18. The home purchasers preferably belong to a home owner's association 20 representing the collective interests of the home purchases. The home owner's association may be any entity representing the home purchasers 18 as a group. In addition, a mortgage company 22 may provide a loan to the home purchaser 18 to buy the home 16.

To provide affording housing, an important component of the present invention is a financing scheme utilizing PIDs to fund a housing project. Public Improvement Districts (PIDs) have been used by municipalities and counties for several years to pay for the cost of capital improvements or maintenance for improvements that benefit a specific number of taxpayers located within a defined district. In its most basic form, it is a method of beneficial financing so parties or taxpayers within the specified district are responsible for payment of capital reimbursement or maintenance cost of public improvements. The method of collection is through a levy by the local municipality of a special tax or assessment on the taxable property within the district. As a result, these are called special tax or special assessment based districts. For example, when a city needs to upgrade the sewer and waste water facilities within a specified area of the city, the city forms a PID that includes only those tax parcels that would benefit from the installation of the improved waste water facilities. The city establishes an additional tax that is collected each year on each tax parcel in the district until the improvements are paid and the city is reimbursed.

Currently, PID districts can also be formed by the petition of a majority of the land owners within the proposed district. Consequently, land owners desiring to install public improvements on their property may petition the local municipality or county and request the formation of a district and then request that the municipality levy a special tax or assessment on the tax parcels within the district in order to obtain reimbursement for public improvements installed that directly benefited the tax parcels in the district.

As discussed above, this reimbursement may take the form of a special ad valorum tax that is levied on each tax parcel. Alternatively, the reimbursement may be in the form of an assessment. The key distinction is that if it is a tax, then a sufficient taxable property in the district is required to meet the tax obligation. If a tax is imposed in anticipation of new construction, and that construction does not occur, then there could be an unfair tax burden on those properties that do have taxable value. Currently, this has been a problem with a number of tax based districts whereby taxes are imposed and building does not occur resulting in a tax rate on those properties that could be taxed being increased unreasonably in order to meet the reimbursement obligation.

The second method of reimbursement of these existing PIDs is assessment-based levies. These levies are structured and applied against each tax parcel regardless of property value on the tax parcel and are levied based on the benefits that each tax parcel received from the improvements as approved by bond underwriters. In essence, this is a beneficial based assessment. For example, if the developer is funding local streets and one lot had twice the front footage of another lot, then the larger lot would bear twice the assessment levy of the smaller lot for the cost of street improvements. The more important advantage of assessment levies is that each levy is separate and distinct from any other levy which can be prepaid in whole or in part at any time, can never be increased, and the non-payment of a levy by one tax parcel has no effect on the levy on any other tax parcel. This is a critical difference from tax based districts where the tax burden within the district is joint and several and a default, non-payment, or lack of development of ad valorum values transfers the tax impact to those properties that can pay.

Another advantage to assessments is a payment can be defined since the assessment is levied when the total value of the improvements to be installed is known or the improvements have been installed. Since the assessment is fixed and can be amortized over a period of time, these assessments can be used as collateral for bond financing to provide the funds to pay for the improvements. The bond buyers buy the bonds knowing that the value of the land after the improvements have been installed will be greater than the amount of the assessment and therefore provide good collateral for the bond buyer.

This ability to use the assessments as collateral is another sharp distinction from tax based districts. In a tax based district, it would not be possible to sell bonds until it is known that a sufficient ad valorum value in the district is attained so it would be reasonable that all properties could pay an ad valorum tax sufficient to pay for the cost of bond retirement. Thus, most tax districts, such as in Municipal Utility Districts and Fresh Water Districts, have bonds that are not sold until a certain amount of residential or commercial construction has been completed.

With assessment based districts, the bonds may be sold to finance the improvements as long as it is certain that the value of the developed land can support the collateral base for the assessment. Historically, many developers would use PID assessments only for reimbursement. The developers would install the improvements and then levy the assessment so they would be repaid over a period of time for the cost of those improvements.

The present invention utilizes these PID assessment programs to fund various projects within a housing development. Bonds may be sold in reliance on the assessments with no liability to a municipality and the bond proceeds used to fund the improvements. Thus, tax-exempt assessment based bond financing is utilized for the developer 12 to fund the projects within the home development 14. Further, since the assessments run with the land, each tax parcel may also be sold with assumption of the assessment or either the seller or the buyer may alternatively pay all or part of the assessment off at any time (or at the time of sale), and when fully paid, it would no longer be a factor for that specific tax parcel. If prepaid, then a corresponding amount of bonds would also be retired.

In the present invention, the home building company 15 purchases its lot inventory from the developer 12 that utilizes a privately financed Public Improvement District (PID) assessment program to fund the majority of the development hard cost of a given project as well as certain soft costs associated with the improvements such as engineering, construction management and capitalized interest charges. As a result, the majority (usually 70% to 75%) of the normal lot purchase price is preferably passed through the lot sales process as an underlying assessment on each lot. The underlying assessment is then fully amortized over a specified period of time, such as 30 years and is assumed by both the home building company 15 and the subsequent new home purchaser 18. This can also be treated by the mortgage company 22 as a down payment, i.e., the “pre-financed” down payment. Thus, the financing of the home, i.e., the assessment, is not recognized as senior debt on the property, but as an assessment only. For the purpose of mortgage qualification and loan to appraisal value, the assessment is recognized as an annual tax charge the home purchaser 18 must pay in consideration of qualification.

By utilizing the financial funding scheme of the present invention, the home building company 15 may purchase lots by assuming the underlying assessment and paying cash for the remaining balance (about 25% to 30%) of the normal wholesale builder lot price for that subdivision. This new lot acquisition program may provide a basic lot inventory to the home building company 15 at a much higher value than its cash investment. For example, the home building company may only have to finance (with a 1^{st} lien) the difference between the lot sales price and the underlying total PID assessment. The initial lot acquisition by the home building company 15 may require a “Letter Of Credit” (or other acceptable guarantee) on behalf of the home building company payable to both the developer 12 and a bond underwriter (not shown in FIG. 1) in order to maintain an approximate 50% “Bond to Risk” ratio. However, the letter of credit will automatically terminate (on a prorata basis) as and when each new home 16 receives a certificate of occupancy which establishes a higher total property value, thereby bringing the “bond to risk” ratio back to an acceptable percentage. Additionally, the 30 year fully amortized assessment may bear interest at a much lower percentage rate than standard lot financing because the bonds sold are tax exempt.

Utilizing the PID assessment program of the present invention, a standard home purchase mortgage may now include all of the standard cash closing costs and still be well under 100% of the purchase price and/or appraised value. Coupled with permanent standard end loans from major mortgage companies, this unique PID assessment program enables the home building company 15 to market all of its new homes with a legitimate “no cash down payment” promotion. This results in a lower blended total mortgage payment for the new home purchaser 18.

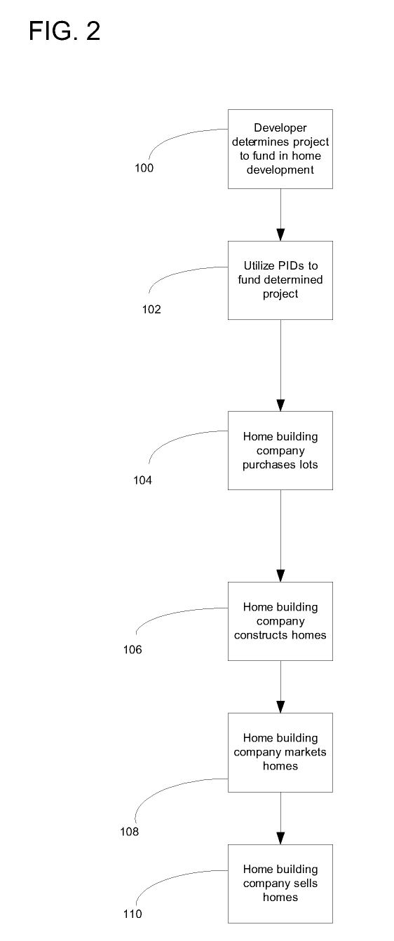

FIG. 2 is a flow chart outlining the steps for funding a private housing project utilizing a PID. With reference to FIGS. 1 and 2, the steps of the method will now be explained. The method begins with step 100 where the developer 12 determines a private project to fund in the home development 14. Specifically, for high cost capital expenditures, the developer determines if the innovative financing scheme of the present invention is desirable for a particular project. Next, in step 102, the developer 12, or alternatively the home building company 15 utilizes a PID to fund the determined project of step 100. The present invention utilizes this PID assessment program to fund the determined project within a housing development. Bonds may be sold in reliance on the assessments with no liability to a municipality and the bond proceeds used to fund the improvements. Thus, tax-exempt assessment based bond financing is utilized for the developer 12 to fund the projects within the home development 14. Furthermore, since the assessments run with the land, each tax parcel may also be sold with assumption of the assessment or either the seller or the buyer may alternatively pay all or part of the assessment off at any time (or at the time of sale), and when fully paid, may no longer be a factor for that specific tax parcel. If prepaid, then a corresponding amount of bonds may also be retired.

The method then moves to step 104 where the home building company 15 purchases its lot inventory from the developer 12 that utilizes the privately financed PID assessment program 40 to fund substantially all of the development hard cost of a given project as well as certain soft costs associated with the improvements such as engineering, construction management and capitalized interest charges. Some projects, such as the non-potable water system may not qualify for PID financing. The underlying assessment is then fully amortized over a specified period of time, such as 30 years and is assumed by both the home building company 15 and the subsequent new home purchaser 18. By utilizing the financial funding scheme of the present invention, the home building company 15 may purchase lots by assuming the underlying assessment and paying cash for the remaining balance (about 25% to 30%) of the normal wholesale builder lot price for that subdivision. This new lot acquisition program may provide a basic lot inventory to the home building company 15 at a much higher value than its cash investment.

Next, in step 106, the home building company 15 constructs homes and the associated infrastructure of the home development 14. The method then moves to step 108 where the home building company 15 markets the affordable homes to the public. Next, in step 110, the home building company sells the home (or transfers title) to a third party (e.g., the home purchaser or mortgage company) for less than full normal value. The PID runs with the property and is likewise transferred. In the preferred embodiment of the present invention, the assessment is used as at least a partial down payment for the purchase of the home. In an alternate embodiment of the present invention, the sale price of the home is reduced by all or a portion of the assessment.

It should be understood that the present invention provides funding utilizing a PID for private housing projects. The PID is any type of financial funding scheme which provides an assessment which runs with the property. The present invention may be used to fund any type of project associated with a housing development.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A system for developing and funding a home development, the system comprising:
a home building company;
a plurality of homes constructed by the home building company and located within the home development, each home located on a lot and purchased by a purchaser; and
a financing scheme utilizing a governmentally authorized assessment program to finance a private project associated with the home development and provide an assessment for each lot, the assessment for each lot is associated with the lot and is transferrable to a third party;
wherein the governmentally authorized assessment program provides funds to fund the project.

2. The system for developing and funding a home development of claim 1 wherein each individual assessment may be transferred to a third party purchasing the property.

3. The system for developing and funding a home development of claim 2 wherein the individual assessment is used as at least a partial down payment for a purchase of the home.

4. The system for developing and funding a home development of claim 2 wherein the individual assessment is used to reduce a purchase price of the home.

5. The system for developing a home development of claim 1 wherein the financing scheme provides a mortgage without a cash down payment to the purchaser.

6. The system for developing a home development of claim 1 wherein the financing scheme is utilized to fund projects dedicated for public use in the home development.

7. (canceled)

8. (canceled)

9. A method of funding a project associated with a plurality of homes located on lots for a plurality of purchasers, the method comprising the steps of:
implementing a governmentally authorized assessment program to fund a specific project within the home development, wherein the assessment program provides funds to fund the project and individual assessments are attached to each lot of each home and the assessment for each lot is associated with the lot and is transferrable to a third party; and
constructing the project utilizing the assessment program funds to fund the project.

10. The method of funding a project associated with a plurality of homes for a plurality of purchasers of claim 9 further comprising the step of marketing the homes with no down payment required for purchasing the home.

11. The method of funding a project associated with a plurality of homes for a plurality of purchasers of claim 9 further comprising the step of purchasing land lots for constructing the homes within the home development utilizing the assessment program to fund at least a portion of the purchase of the land lots.

12. The method of funding a project associated with a plurality of homes for a plurality of purchasers of claim 9 wherein each individual assessment may be transferred to a third party purchasing the property.

13. The method of funding a project associated with a plurality of homes for a plurality of purchasers of claim 12 wherein the individual assessment is used as at least a partial down payment for a purchase of the home.

14. The method of funding a project associated with a plurality of homes for a plurality of purchasers of claim 12 wherein the individual assessment is used to reduce a purchase price of the home.

15. The system for developing and funding a home development of claim 1 wherein a portion of the assessment is credited as a pre-financed portion of a purchase price of the home to the purchaser.

16. The system for developing and funding a home development of claim 1 wherein a portion of the assessment is credited as a pre-financed portion of a purchase price of the lot to the home building company.

17. The system for developing and funding a home development of claim 1 wherein the assessment is amortized over a specified period of time by the purchaser.

18. The system for developing and funding a home development of claim 17 wherein a portion of the assessment is utilized by the purchaser as a down payment for a mortgage on the home.

19. The system for developing and funding a home development of claim 17 wherein a portion of the assessment is utilized to reduce a sales price of the home or lot for purchase by the purchaser.
